(19) United States
(12) Patent Application Publication
(10) Pub. No.: US 2013/0291749 A1
(43) Pub. Date: Nov. 7, 2013

(54) METHOD AND APPARATUS FOR DETERMINING AND SETTING AN OPTIMIZED OPERATING DISTANCE BETWEEN AT LEAST TWO CYLINDERS INVOLVED IN A PRINTING PROCESS

(71) Applicant: Manfred Loddenkoetter, Ibbenbueren (DE)

(72) Inventor: Manfred Loddenkoetter, Ibbenbueren (DE)

(21) Appl. No.: 13/696,700

(22) PCT Filed: May 9, 2011
(86) PCT No.: PCT/EP2011/057417

§ 371 Date: Jan. 22, 2013

(30) Foreign Application Priority Data
May 7, 2010 (EP) 10162344.5

(51) Int. Cl. B41F 13/14

(52) U.S. Cl. CPC B41F 13/14
USPC 101/481; 101/485

(57) ABSTRACT

The subject matter of the document is a method for setting an optimized operating distance between at least two cylinders of a printing unit, said comprising at least two cylinders,
wherein said cylinders transport ink in an ink-transporting direction during the printing process,
wherein the method sets the distance between the at least two cylinders, of which a first cylinder transfers ink during the printing process and a second cylinder receives ink from the first cylinder during the printing process,
wherein the optimized operating distance between the at least two cylinders is set based on the measured values from a sensor device,
and wherein the sensor device records the change in the film of ink which occurs on at least one cylinder which is involved in transporting ink to the printing material, characterized
in that the at least one cylinder, at which the change in the film of ink is recorded, is a cylinder which is mounted upstream, when viewed in the ink-transporting direction of the second cylinder, which receives ink during the printing process,
and in that the change in the film of ink on the cylinder, this change being recorded by the sensor device, consists in the removal of the ink or in the change in the surface of the film of ink as a result of a contact pressure.

The invention relates to a method according to the preamble of claim 1 and an apparatus according to the preamble of claim 25. Using an apparatus and method of this type, the distance between at least two cylinders of a printing unit involved in the printing process are set.

This is necessary for various printing methods prior to the initiation of the actual printing operation. Thus, DE 44 27 967 B4 could be assigned to the offset printing method. This citation suggests feeding a paper strip through between two ink-transporting cylinders. The width of the region provided with ink in this manner is subsequently measured. In particular, if the region is too small, the setting between the rollers in question is increased.

The optimization of the setting is of particular interest in the field of flexography, as in this case relatively thick, very flexible printing plates are used, which—in particular together with the substructure thereof—have large thickness tolerances. In this context, EP 1 249 346 B1, among others, suggests using optical sensors to observe the print image of the printing machine on the printing material for setting the rollers. A control device determines the optimized relative position of the rollers involved in the printing process to one another based on the measured values and sets this position. As, according to this teaching, the measurement of the—still flawed—print image on the printing material is the foundation for setting the print roller position, spoilage is inevitably generated during the setting of the roller position.

This circumstance is criticized by EP 1 916 102 A1. As a remedy, this document suggests measuring the diameter of the plate cylinders. Based on the measurement results obtained at the plate cylinder, a control device determines the optimized relative position of the plate cylinder to the other cylinders involved in the printing process. Based on these values, the control device of the printing machine sets the position of the plate cylinder in the printing machine. In this way, a proof should be pulled without spoilage.

This teaching, however, disregards the fact that, in addition to the pure diameter of the printing plate, variables such as the modulus of elasticity or the color splitting behavior of the respectively printed ink also influence the printed result.

A further document, which addresses the optimization of ink transfer from the rollers involved in the printing process in the offset printing process, is DE 102 11 870 A1, which suggests moving rollers, which transfer ink in the printing process, toward one another in the idle state (no rotation around the primary axis of symmetry). If the first of the two rollers in the ink-transportation direction is inked at the moment of the mutual adjustment, a strip of ink arises on the second roller. This strip of ink is clearer if the two rollers touch each other for a period of time in the idle state.

This strip of ink can be measured using a Line scan camera, among others, after the second roller has been rotated around an angle from the contact position to another position, in which the strip of ink generated can be seen.

The width of the strip of ink is a measurement for the contact pressure between the rollers, such that the correct pressure can be assumed at a certain width. In case the strip has a rectangular shape (equal widths), the primary axes of symmetry of the two rollers are moving parallel.

Beyond this, the strip of ink itself, which consists of dried ink, can reduce the printing quality at the beginning of printing, and thus lead again to the accumulation of spoilage.

The present invention arises from the last-cited document. The object of the invention is to remedy the previously cited disadvantages.

The problem is solved by the characterizing features of claims 1 and 25. The change in the film of ink can consist in a removal of ink, which is transported by the cylinder in question. It can also, however, come about without a removal of ink, such that the surface of the film of ink changes as a result of a contact pressure. Further details of the phenomena mentioned are primarily discussed in the objective description.

A basic concept of the present invention thus consists in detecting the change in the film of ink on an ink-transferring cylinder. In so doing, the measurement is carried out on at least one cylinder, which is mounted upstream in the ink-transport direction (23) of the second cylinder (7) which receives ink during the printing process.

Expressed differently, a measurement is taken at a cylinder, which is mounted upstream from the roller gap in the ink-transport direction, wherein the roller gap of the two cylinders is delimited by the two cylinders, the pitch thereof being set. A measurement can also be taken at the first cylinder which delimits the gap. Alternatively or supplementally, a measurement can also be taken at an additional cylinder mounted upstream in the ink-transport direction.

In the manner described, an ink transfer, which comes about using realistic preconditions, can also underlie the detection of the optimized relative position of the rollers, without causing necessary spoilage. Thus, when using a flexographic printing press, the adjustment between anilox roller and plate cylinder is optimized on the basis of the observation of the anilox roller, without causing spoilage. An adjustment of the roller unit, anilox roller/plate cylinder, being well positioned against one other, at the impression cylinder can then be carried out while producing spoilage. Tests have shown that in the ultimately mentioned case, it is also possible to determine the contact between the plate cylinder and the printing material on the anilox roller: In this case, ink streaks, which have formed on the printed material due to insufficient ink transport, now disappear.

It should be added that the relative position of the two cylinders already adjusted with respect to one another—in this case anilox roller and plate cylinder—should advantageously not change during the adjustment at the impression cylinder.

At this point, it should be explicitly mentioned once more, that an impression cylinder, which guides the printing material at the surface of said cylinder, so that ink is transferred to the printing material in the printing operation, is also, within the meaning of this citation, an ink-receiving cylinder.

The previously mentioned method for optimizing the plate cylinder position according to DE 102 11 870 A1 additionally requires a large expenditure in time, as the cylinders must be paused for a certain period of time, as mentioned, so that the ink strip develops on the second cylinder.

With regard to the inventive method, it is advantageously possible to analyze the film of ink at the rotating cylinders. In this case, the cylinders can continue to rotate. It is advantageous to carry out at least one continuous rotation (360° around the primary symmetrical axis), at least two or more rotations of this type. During a part of the inventive method, the cylinders rotate during the entire test or sensing run.

Interestingly, it is also possible to measure a contact between downstream mounted ink-transporting cylinders at an upstream mounted cylinder, without implementing a printing process, that means without ultimately transporting the ink to the printing material.

It is, however, advantageous in exactly this context to conduct the measurement and adjustment of the operating distance within a few rotations (e.g., 1, 2, or 3), because otherwise saturation effects develop in the region of the contact surface.

As a rule, the adjustment of the roller distance based on the measured values is implemented by a control device installed for this purpose. For this purpose, the control device is, as a rule, loaded with a corresponding computer program. Anyway, it is advantageous to carry out or support all inventive methods as computer-implemented in this way.

This method is also advantageous in the case of the presence of only two rollers. Thus, for example the removal of ink from the gravure cylinder—that is the printing plate cylinder—is measured in the case of gravure printing machines. The impression roller or general impression cylinder is involved in the printing process in this case; however, it is not involved in the transport of ink to the printing material or into the print gap.

By this means, the method has advantages for two rollers as well as for a transport of ink via a multiplicity of cylinders and a measurement of the film of ink at one of the previous rollers. As mentioned, the covering of the surface of the roller with ink also changes in the ultimately mentioned case, when the rollers downstream in the ink-transporting direction are contacted against the subsequent roller or the printing material, and ink is actually transported onto the printing material.

As has likewise already been addressed, it is advantageous to observe the film of ink at an anilox roller used for example in flexographic printing. Said rollers primarily lose ink when further cylinders are contacted.

In various printing methods, however, smooth rollers are also used for inking further rollers involved in the printing process.

It should be added at this point, that the terms roller and cylinder are used in this document as interchangeable or equivalent to one another.

In determining the optimized relative position of the at least two rollers, the question is: how strong the change in the area of coverage on the roller must be, so that the control device has initial reference points for an optimized roller distance and ends the test run. In this context, “test run” is understood as the phase of convergence of the rollers, during which the measured values are obtained, which are used to determine a first optimized relative position.

A possibility exists thereby to end the test run as soon as a change in the film of ink is indicated at the roller at which the measurement is taken. Naturally, the amount of ink, which is transferred at this point in time, is dependent on the sensitivity of the measurement system. As a rule, however, in this way a contact situation could be found, which is known to printers as “kiss print.” At this point, a first, light contact between the rollers occurs.

At this point, for example, the further measurement of ink transfer can be ended. A further convergence can, however—as needed—be implemented by the control device. Thus, after achieving this “kiss print point,” or in this case a first optimized relative position, an adjustment of the cylinders toward one another by an empirically or computationally determined offset value—thus a further convergence of the cylinders by an amount of distance—can be effected by the control device. In this way, an optimized operating distance between the effected cylinders can be achieved, which is indeed as a rule not yet fulfilled by achieving a kiss print point.

An essential alternative to this process consists in that the convergence of the cylinders is further continued at simultaneously analyzed measurement—“the test run”—until a primary threshold value or tolerance value is achieved—in this case the removal of ink. This primary threshold value can be selected such that the optimized operating distance between the cylinders is already achieved upon exceeding the primary threshold value, such that no further measures are required in this regard. According to this, the adjustment of the relative positions of the rollers would be ended at the end of the test run and the optimized operating distance would coincide with the first optimized relative position. However, upon reaching this threshold value for the removal of ink at the cylinder, at which the measurement is taken, a further convergence of the cylinders by an amount of distance (“offset value”) can additionally be implemented.

A further possibility for determining an optimized print infeed situation consists in tracking the course of the removal of ink as a function of the relative roller position. The possibility then exists, at the onset of a characteristic progression of this function, based on experience and calculations, to assume the achievement of the optimized relative position of the cylinders. Thus, achieving the optimized print position of the cylinders often shows prematurely, because the ink transfer scarcely increases after reaching this position, but instead enters into the saturation range at further convergence of the rollers. Due to these issues, the function under discussion often has turning points or relative maximums in the range of the optimized print position. Characteristic points of this type can be used by the control device for determining the optimized printing position. Often, an optimized relative print position determines a “secondary threshold value” (i.e., a further amount of ink removal) or an “offset value” (i.e., a certain amount of distance) at a distance from a characteristic point of this type. If the progression of the function is recorded far enough to calculate the position of such points, the test run can also be ended at this point.

Method steps like recording the function of the change in the film of ink/relative roller position, ending the test run, detecting one or more characteristic points of this function, overriding a threshold value and/or offset value, can be carried out in a computer-implemented way by the control device. This also applies naturally for the other methods introduced in this document.

It should be gathered from the previous embodiment, that the offset values and the secondary threshold values can be used in conjunction with all of the methods presented, which determine the duration of the test run. The mathematical sign of the offset value (“more or less infeed”) or the secondary threshold values (more or less ink transfer) can be positive or negative.

It is advantageous to limit the region of the cylinder or of the roller, at which the measurements are taken, to the region in which ink can be removed. As a rule, the maximum measuring range of the sensor device is therefore oriented at the maximum print range (often the same or somewhat larger). A possibility for realizing this consists in the use of a line scan camera, which can display the maximum printing width. This camera is suspended at the affected cylinder in a working position, in which it can scan the print range of the machine. It makes sense to disassemble the entire measuring range of the sensor system into sections. The sensor system itself can already be modularly constructed—e.g., from photo diodes. In this case, the modules of the sensor system already deliver partial images of the entire measuring range, which then no longer need to be disassembled into sections by a calculating unit.

In addition to the disassembly of the entire contact surface possible between two cylinders into various sections, it is also worth considering the measurement of the change in the film of ink in a subset of the sections. Thus, under certain circumstances, a measurement in a one square centimeter large section can suffice. With new sensors, sections with an area in the range of a square millimeter are also conceivable. As compression rollers are mounted at the two face ends thereof, it is therefore advantageous to carry out measurements in the respective region of one or both faces, in order to obtain measured values for each of the two sides. In particular, in fields of print technology, in which large tolerances at printing plates and rollers are considered—as in packaging printing—a plurality of measurements is advantageous.

If measurements are carried out in a plurality of sections, then the previously sketched methods for determining the optimized relative print positions of the cylinders involved are advantageously applied to the sections. The optimized contact situation may be considered to be advantageously achieved when the conditions of the respective method are satisfied in a subset of sections.

As mentioned, optical sensors such as cameras can be considered as sensor devices. The expression, “optical sensors and cameras” is then also used in this context, when non-visible electromagnetic radiation is recorded.

If electromagnetic radiation is measured, then the prismatic light intensity is an advantageous measurement variable (light intensity per prismatic range per surface). In this case, it is advantageous to provide a specific radiation source, which radiates the appropriate radiation on the roller. The sensors then measure the remitted radiation. When mounting the radiation sources and sensors, the laws of reflection should generally be observed (as is shown, among others, in the figures).

A device for determining an optimized operating distance between two cylinders involved in the printing process can be equipment specific to a printing unit or can be, from the view of the printing machine, an external rack with corresponding additional measures. A commonality of these devices is that recesses are provided, in which the impression cylinders are rotatably mounted and adjustable with respect to one another. In addition, the preparation of the impression cylinder for printing, that is, equipping with the printing plate, can take place in an external rack. For this purpose, a rack of this type can be additionally equipped with device features, which are appropriate for the so-called mounters that are typically used for equipping flexographic impression plate cylinders. A device of this type is described for example in U.S. Pat. No. 5,132,911 B. In more recent times, rack-type devices have also become known in the field of the preliminary stage of flexography, in which devices a plate cylinder is likewise rotatably mounted. Said cylinder is, however, provided with a smooth, still completely unprocessed, rubber type cliché, which is processed by a laser ablation unit to form the desired printing plate. An inventive apparatus can also be equipped with a laser ablation unit of this type or another gravure unit for processing the cliché. A unit of this type is shown in WO 9713641.

If the invention is realized in an external unit, then it is also not necessary to actually set the relative distance ultimately considered to be optimal between the participating cylinders in the external unit. On the contrary, it is necessary in this case to forward the data determined to the actual printing machine, which then also sets these values. For this forwarding of information, all known possible means of communicating between the devices come into consideration, as well as a memory in the relevant cylinders (e.g., RFID with read options in the printing machine).

An inking device is among the device components that are as a rule present in an inking system, but which are generally lacking from an external rack. A rudimentary inking device of this type can be mounted for the purpose of an external rack. Said device can also be loaded with a specific test ink. A test ink of this type can have similar color splitting characteristics, yet have different optical characteristics (“easier to measure”) from the actual ink.

In particular, the performance of the film of ink on a roller—in the rack or in the inking device—can also be determined by capacitive sensors when using extensively dielectric inks. In this case, it is easy to recognize that the thickness of the film of ink on the surface of the roller, at which measurements are taken, influences the capacitive measurement. However, even an uneven structure of a film of ink may play a role here.

The development of the film of ink on the roller can also be observed during the printing operation by using the inventive inking device. In this way, dynamic changes in the printing conditions can be recognized with respect to the printing operation. It is possible to react to these changes in the ongoing printing operation (e.g., by a different adjustment of the rollers or by changing the viscosity of the printed ink).

At this point, it should be mentioned once again that the change in the film of ink on the at least one ink-transferring cylinder can be carried out while the roller is rotating. The measurement can take place while the cylinders—for example the cylinders for which the relative position is optimized—are adjusted toward one another in the vicinity of the kiss print point of said cylinders and, if necessary, while a test run for determining an optimized printing position takes place. A displacement of the rollers away from one another to implement the measurement is generally unnecessary.

In the subsequent description of the subject matter, sensors are shown that are mounted in an operating or measuring position at an ink-transporting roller. Radiation sources are also often provided with respect to optical sensors—cameras. It has been demonstrated that, by means of measurements at the ink-transporting rollers, which measurements are possible using the indicated sensors, still other variables or phenomena, which are relevant to the printing process, can be measured or determined. These are subsequently explained with reference to the observation of a flexographic printing anilox roller:

Evaluation of the Negative Image

It has been surprisingly demonstrated that, when using suitable sensors, a clearly visible negative image of the print motif stands out on the anilox roller. Said negative image can be compared with the target image of the print image, which target image is often known from the preliminary printing step and which is often available in electronic format (e.g., pdf). In this way, errors can be recognized before they occur—likewise while generating spoilage.

Inking Monitoring

The performance of the inking of the anilox roller—which as a rule takes place using a doctor blade chamber—can be monitored prior to or during the printing process. This is very important as it can always occur that little or even no ink is on the roller, which naturally negatively influences the print image. Running rollers of all types when dry can, however, also cause combustion and explosions in printing machines, such that the recognition of dry rollers can be used for “explosion protection” (e.g., printing abort or warning signal).

Ghosting or Doctor Blade Streaks or Oscillations

Ink deposits, which can lead to so-called ghosting, or doctor blade streaks, which can come about due to a too strongly adjusted and/or vibrating doctor knife on the surface of the anilox roller, can be recognized using the sensors. As a remedy to ghosting, the anilox roller can be cleaned. During printing operation, more solvent can be fed. For the doctor blade streaks, a counter measure is to justify the doctor blade. Streaks on the anilox roller can come about due to oscillations in the inking device. Oscillations of this type often lead to regular thickness fluctuations of the film of ink on the roller.

Dynamic Measurement

As has already been mentioned above, changes in the film of ink on an ink-transporting roller can also be measured during the printing operation. An additional optimization of the roller position can result based on the measurements of the sensor system with respect to such changes. Measures of this type are advantageous, as changes in the parameters are set based on dynamic changes in the printing operation. Therefore, in general, additional measurements are made at increasing print speeds.

Registration or Pre-Registration

Based on significant points in the above-mentioned negative image of the print image on the anilox roller, or based on register marks provided for this purpose, which register marks are likewise displayed in the negative image, a registration or pre-registration of the printed-image carrying cylinder—the plate cylinder in flexography—can be carried out at the printed-image carrying cylinder by at least one additional inking device. For this purpose, the significant point or the mark on the surface of the anilox roller is recognized at this point in time, and the angle position of the anilox roller at this point in time is recorded, e.g., using a rotary position transducer. A significant point or a mark on the surface of the anilox roller of the additional inking device must then be brought into a suitable relative angle position. This circumstance would likewise be checked using an optical sensor and a rotary position transducer. This method would enable, for example, a spoilage-free pre-registration.

The previous methods can be advantageously combined with the method for setting the relative position of the at least two rollers involved in the printing process. Both types of methods have surprising advantages when they are implemented based on measurements at cylinders with uneven surfaces—such as anilox rollers, plate cylinders, or printing cylinders.

Lower signal-to-noise ratios result as a rule from smooth rollers.

Further embodiments of the invention arise from the description of the subject matter and the claims.

The individual figures show:

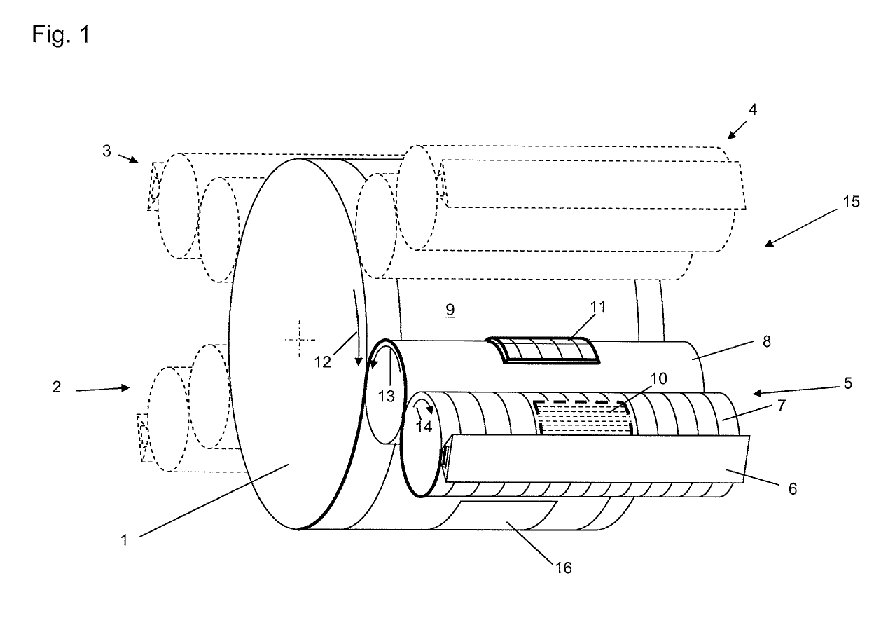

FIG. 1. A functional diagram of a first central cylinder flexographic printing machine

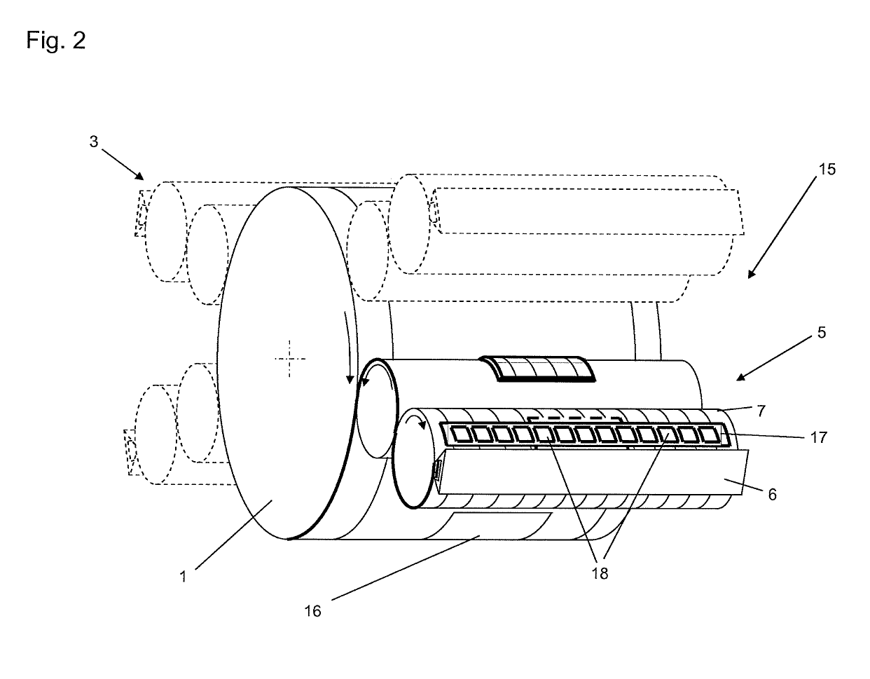

FIG. 2. A functional diagram of a second central cylinder flexographic printing machine

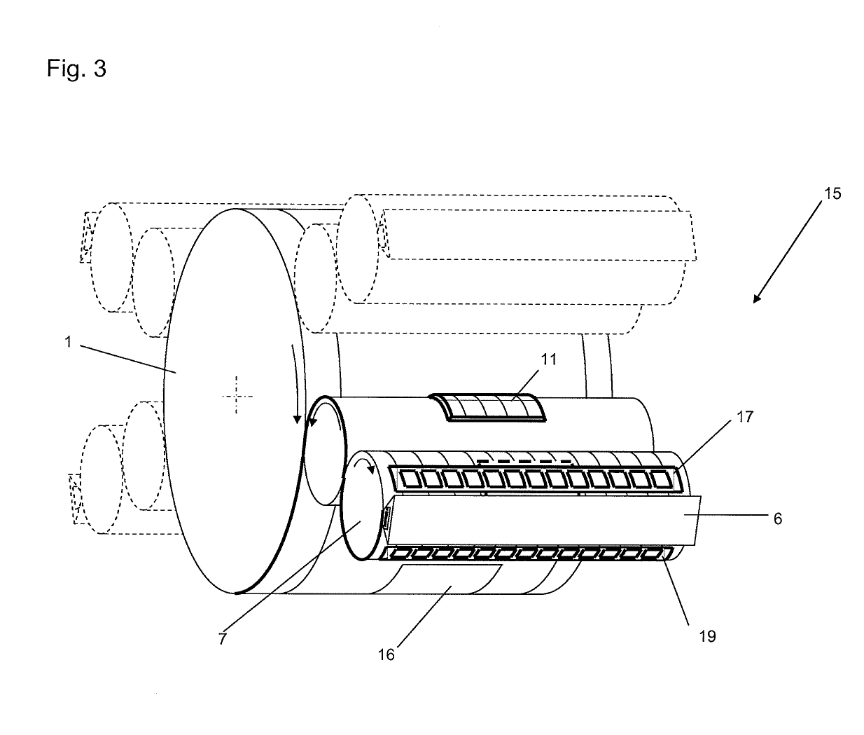

FIG. 3. A functional diagram of a third central cylinder flexographic printing machine

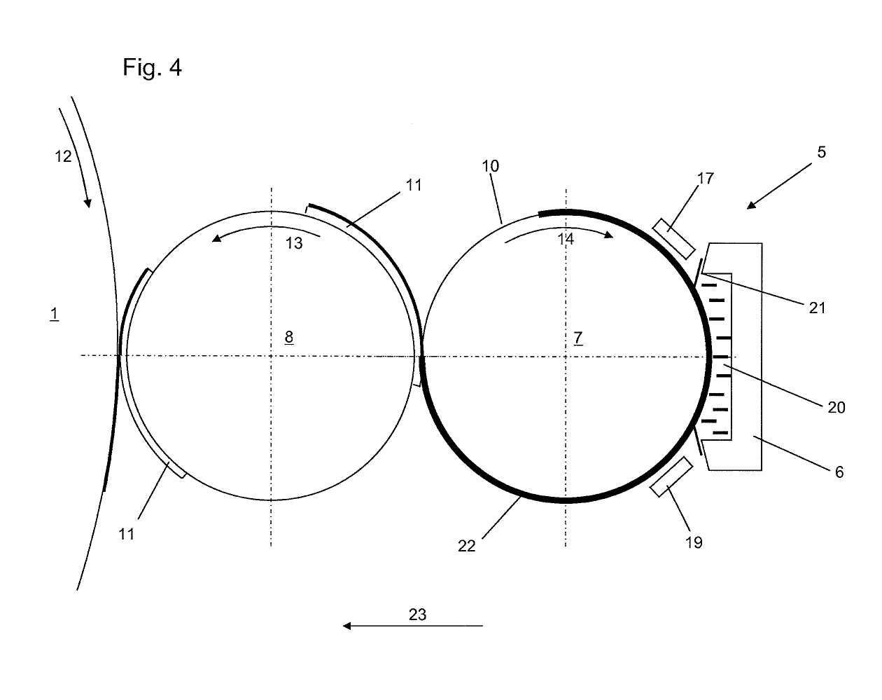

FIG. 4. A schematic sectional view of the inking device 5 of the third central cylinder flexographic printing machine

FIG. 5. A functional diagram of a fourth central cylinder flexographic printing machine

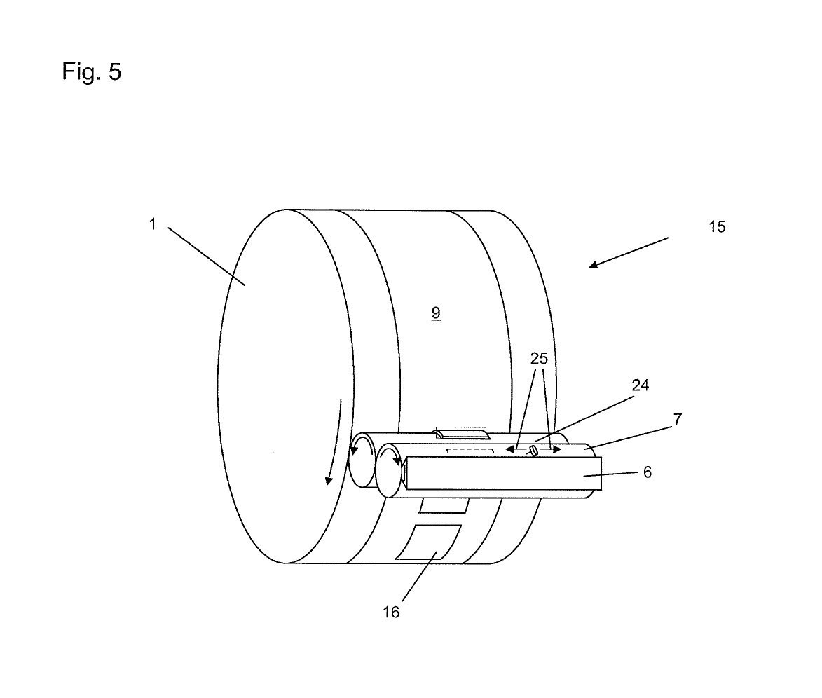

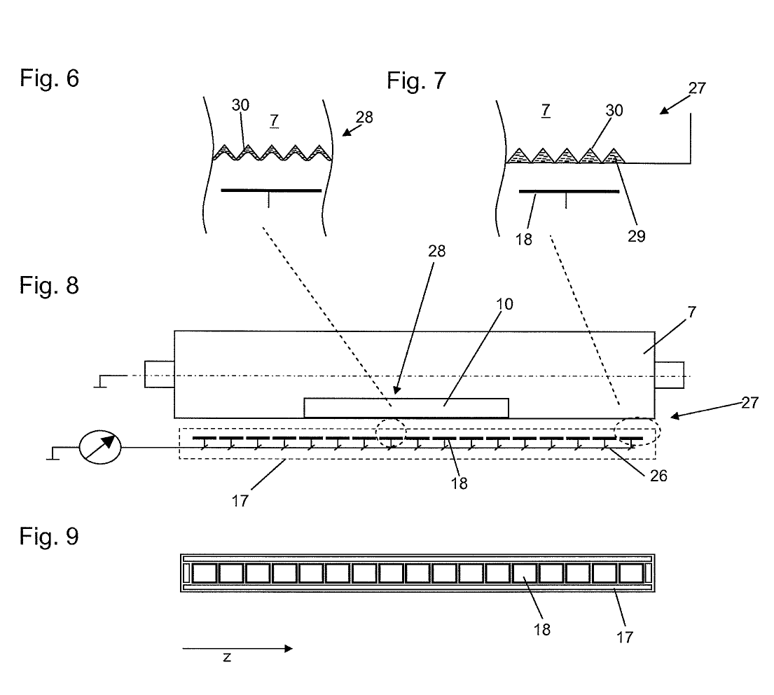

FIG. 6. A first detail from FIG. 8

FIG. 7. A second detail from FIG. 8

FIG. 8. A diagram of an anilox roller and a sensor system

FIG. 9. A second view of the sensor system from FIG. 8

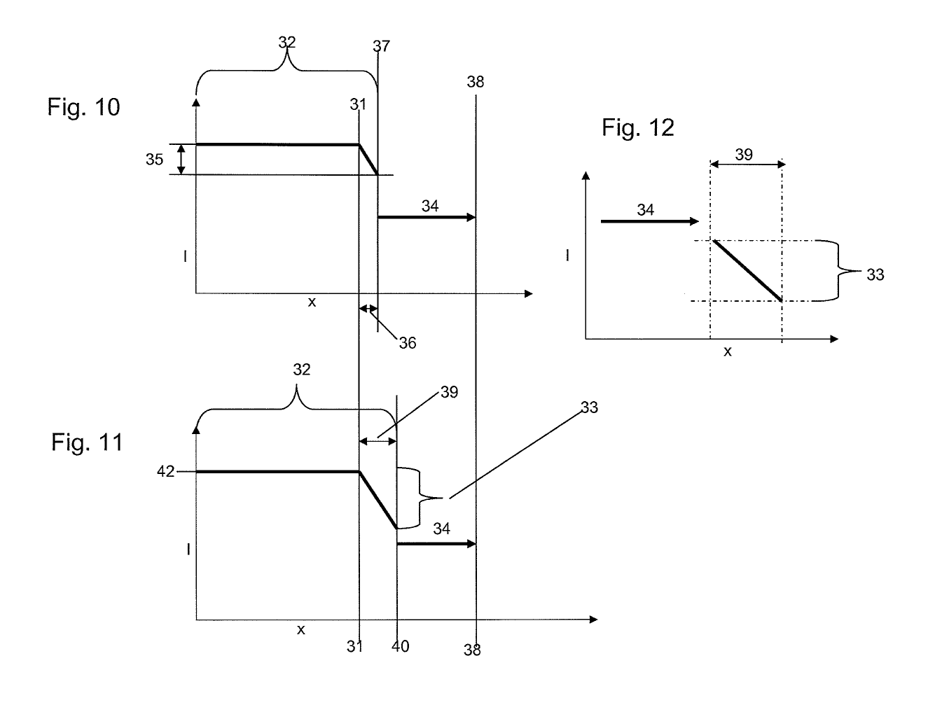

FIG. 10. A visualization of a first measuring method

FIG. 11. A visualization of a second measuring method

FIG. 12. A visualization of a few concepts

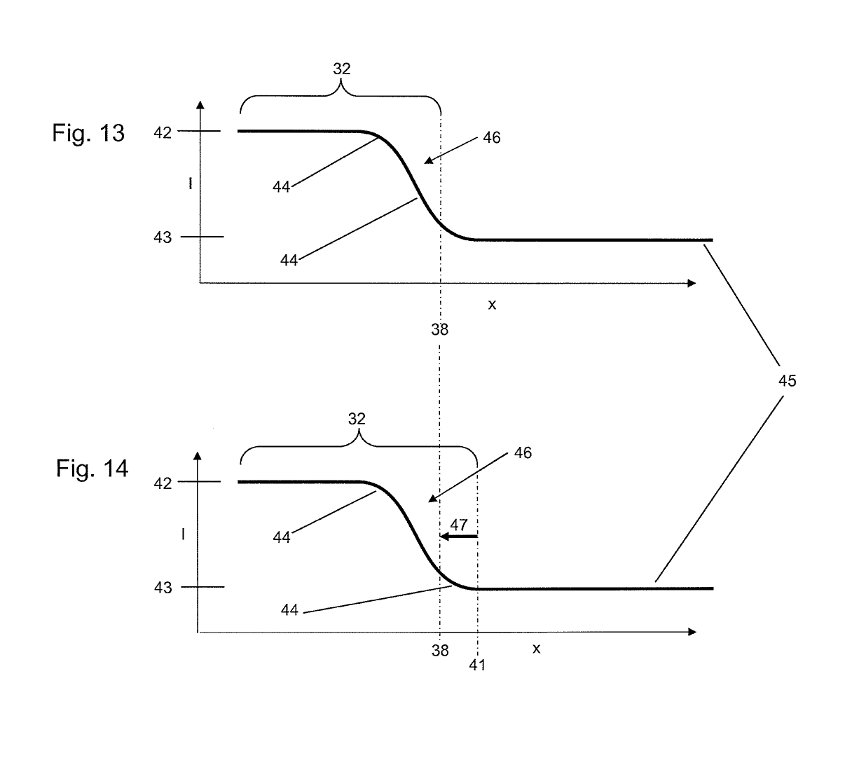

FIG. 13. A visualization of a third measuring method

FIG. 14. A visualization of a fourth measuring method

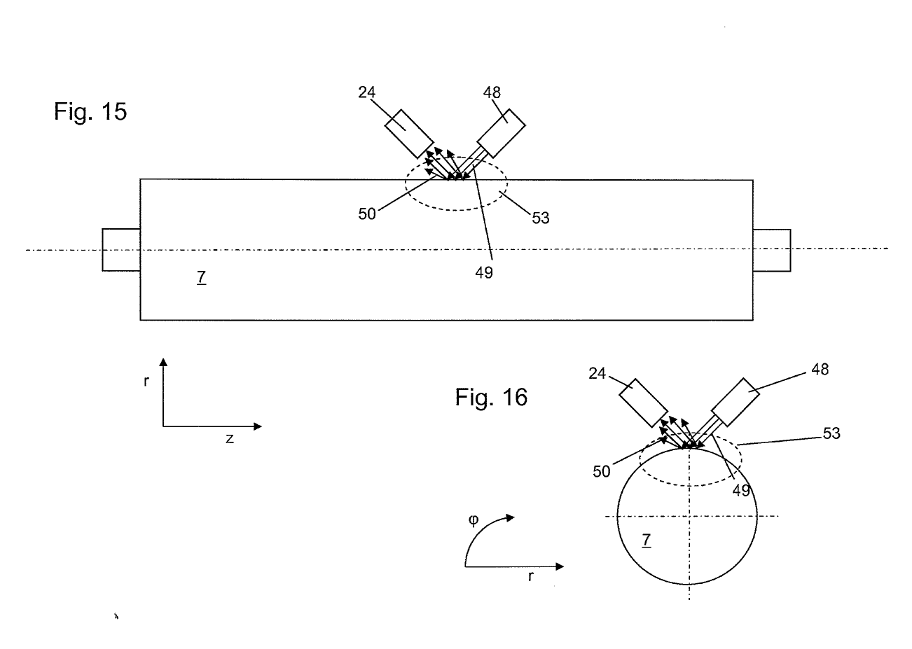

FIG. 15. An anilox roller and a camera

FIG. 16. A further anilox roller and a camera

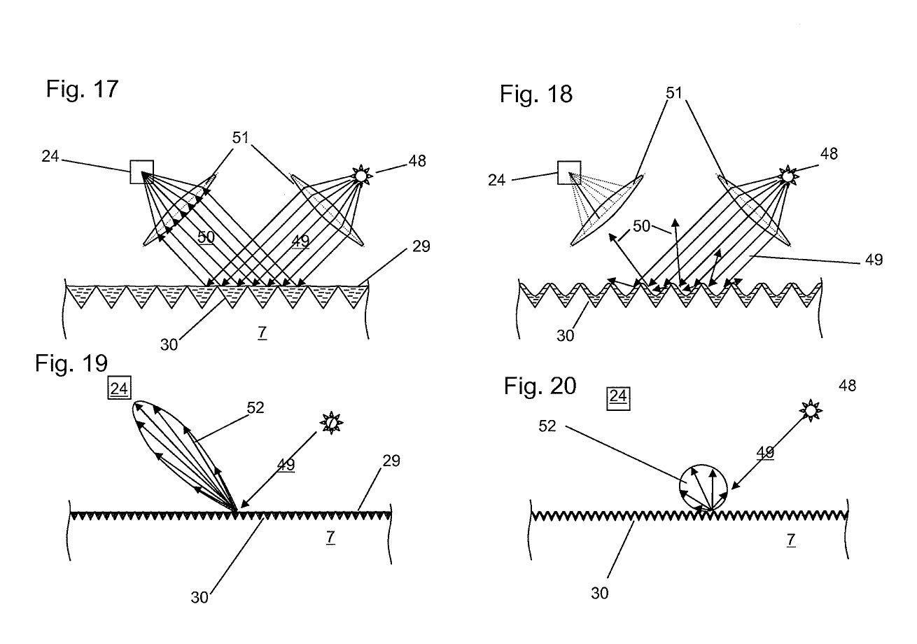

FIG. 17. An enlargement of the surface of an anilox roller 7 in sectional view

FIG. 18. The sectional view from FIG. 17 with empty cells 30

FIG. 19. A further enlargement of the surface of an anilox roller 7 in sectional view

FIG. 20. The sectional view from FIG. 19 with empty cells 30

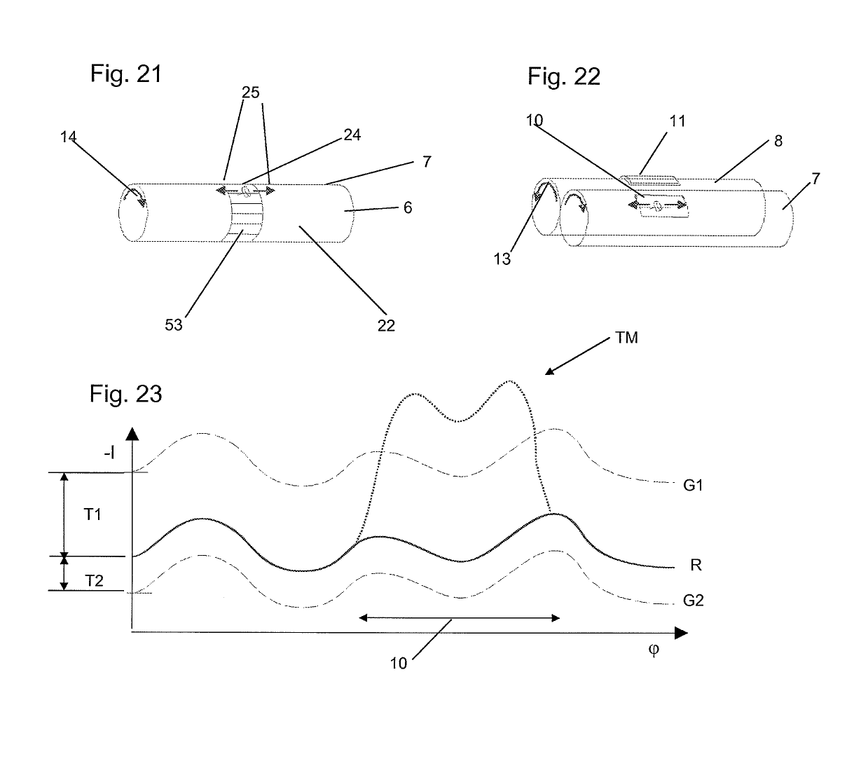

FIG. 21. A diagram of an anilox roller 7, which is scanned by a mobile camera

FIG. 22. The diagram from FIG. 21, whereby a plate cylinder is adjusted at the anilox roller

FIG. 23. The progression of the intensity of light remitted by the anilox roller as a function of roller rotational angle φ

FIG. 1 is a schematic diagram of a central cylinder flexographic printing machine 15, in which the printing units or rather the inking devices 2, 3, 4, and 5 are arranged around the central impression cylinder 1. The inking devices 2, 3, and 4 are represented solely with dashed lines, as a more exact consideration of the inking device 5 is sufficient at this point.

At this point, the doctor blade chamber 6 transfers ink to the surface of anilox roller 7. Said 7 further transports the ink by means of the rotation of the roller to the plate cylinder 8. The plate cylinder 8 supports the embossed cliché 11, which receives the ink from the surface of the anilox roller 7. Therefore, a zone forms on the surface of the anilox roller 7 in the contact region 10 between the cliché 11 of the plate cylinder 8 and the anilox roller 7, in which zone ink loss occurs. It is applicable to measure this ink loss in a printing machine 15, as is shown in FIG. 1, before the contact region 10 again reaches the doctor blade chamber 6 due to the rotation of the anilox roller 7. In addition, it can be necessary for more exact measurements to measure the ink loss per surface unit. In case this should occur quickly and during a test run, a measurement at a rotating roller 7 is advantageous.

The cliché 11 transfers the ink to the printing material 9, which is transported on the circumferential surface of the impression cylinder 1. In the lower region of FIG. 1, the print image 16 on the printing material can already be seen.

A diagram largely identical to FIG. 1 can be seen in FIG. 2, in which diagram the same reference numbers also identify the same features. The line scan camera 17 is, however, added, the width thereof corresponding to the maximum printing width. The camera is modularly designed. It comprises modules 18, in which photodiodes can record sections of the anilox roller 7. In the diagrammed operating situation of the printing machine 15, only the middle modules 18 of the camera 17 are activated. These modules are already in a position to completely or partially scan the contact region 10 of the surface of the anilox roller 7 with the cliché 11, when said region 10 moves past the camera 17 due to the rotation of the anilox roller 7.

As a rule, the line scan camera 17 is already equipped with its own radiation sources, which radiate radiation on the contact region 10.

FIG. 3 again shows a principally identically structured printing machine 15. In addition to the camera 17, already shown in FIG. 2 and mounted upstream of the doctor blade chamber 6 in the rotational direction 14 of the anilox roller 7, camera 19 can be seen, mounted downstream of the doctor blade chamber 6 in the rotational direction 14 of the anilox roller 7. Using this camera, the performance of the inking of the anilox roller 7 by the doctor blade chamber 6 can be controlled.

A configuration of this type can also be seen in the sectional representation of the inking device 5 in FIG. 4. In this case, the plate cylinder 8 is shown with two clichés 11. As depicted, the anilox roller 7 does not have any unaffected film of ink 22 in the contact region 10, as in the remaining circumferential surface of said roller. In the sectional representation of the doctor blade chamber 6, the ink reservoir 20 thereof and the doctor blade 21 thereof can also be seen. The arrow 23 symbolizes the transport direction of the ink.

A further advantageous embodiment of the method can be depicted by means of FIG. 4:

By this means the operating distance between a first group of cylinders 1, 7, 8 involved in the printing process is set, wherein the first group has a first number N of cylinders, and the first number is at least three,

wherein the operating distance between a second group of cylinders 7, 8 involved in the printing process is set based on measured values, which relate to the change in the film of ink on at least one of the two cylinders, wherein the second group is a subset of the first group, the second group has a second number M of cylinders, and the second number M is at least two,

and wherein the operating distance between a third group of cylinders 1, 8 involved in the printing process is set based on measured values, which are obtained in a different way from the measured values used for adjusting the operating distance between the cylinders of the second group from cylinders involved in the printing process, wherein the third group is a subset of the first group, the third group has a third number O of cylinders, and the third number O is at least two.

In the flexographic inking device 5 depicted in FIG. 4, the first group of cylinders involved in the printing process comprises the impression cylinder 1, the plate cylinder 8, and the anilox cylinder 7. It is advantageous to form the second group from the plate cylinder 8 and the anilox cylinder 7. If these two cylinders are adjusted to one another while they rotate, no spoilage is generated despite this.

The third group can be formed from the impression cylinder 9 and the plate cylinder 8. The adjustment of the optimized printing position for these two cylinders can take place in a different way and manner in order to reduce spoilage.

Another method of this type for setting an optimized printing position is disclosed in the as yet unpublished German patent application with the application number 10 2009 025 053. It is expressed in this citation that one cylinder rotatably involved in the printing process is contacted against another cylinder. A velocity gradient prevails between the surfaces of the cylinders, such that the drive of at least one of the two cylinders expends additional torque. Recourse to the teaching of the German patent application with the application number 10 2009 025 053 is explicitly reserved to round out the present teaching.

With regard to the teaching of the German patent application with the application number 10 2009 025 053, it is especially important how the drive of the printing machine should be equipped in order to perceive the change in torque. In addition, the way and manner, in which the cylinders in the German patent application with the application number 10 2009 025 053 are contacted against one another is of great importance. Also, the evaluation of the measured values and the actual optimizing of the printing position can be included for rounding out the method presented in the present document.

The teaching of the German patent application with the application number 10 2009 025 053 permits the adjustment of the printing position—among others, for impression cylinder 9 and plate cylinder 8—at extremely low printing speeds or even at the idle state of the impression cylinder 9. Thus printing also can take place with little spoilage or with none due to the combination of these methods.

FIG. 5 shows again the printing machine 15 in a similar way as FIGS. 1 to 3. However, this time the mobile camera 24 is shown in the inking device 5 instead of the line scan camera 17. Said camera is movable along a profile (not shown) in the axial direction of the anilox roller 7. This is indicated by the arrow 25.

The camera depicted in FIG. 5 can cover at one point in time only sections of the contact surface 10 between the cylinders 7 and 8. It would also be possible to provide a plurality of mobile cameras 24 of this type, or to stationarily mount one or more cameras that can only cover small sections of the area.

It has been shown that cameras of this type are also fully sufficient for certain application cases. Sensors, such as reflection sensors and/or light sensors, which already find use in series printing machines as register sensors, can be considered as cameras with small fields of view (magnitude in the square millimeter range). Said sensors are equipped with optical fibers (as a rule fiberglass-based), which conduct light to the observation region as well as derive the light reflected by the roller surface, which light serves for measurement (as a rule, after is collected by a lens or something similar). Thanks to the optical fiber, the radiation source as well as the analysis unit are located in a safe mounting position at a distance from the measurement point. The sensors listed should be acquired as seamlessly integrated components (among others, mechanically resilient and relatively insensitive to chemical influences). It is also possible, thanks to the optical fibers, to adjust the positions of the light-emitting and light-remitting components (transmitter and receiver) as well as the roller surface, such that a large part of the remitted light falls back on the receiver and the measurement is carried out (as a rule using photodiodes). The generation of the light is realized as a rule using LEDs. Often, light is hereby generated that is calibrated in color with the ink of the roller to be tested. This measure is helpful with regard to all radiation sources in conjunction with the teaching introduced here.

FIG. 9 shows once again the line scan camera 17 assembled from the modules 18, which camera is mounted upstream of the doctor blade chamber 6 in the rotational direction of the anilox roller 7 in FIG. 2. The orientation in the z direction also corresponds to the symbol of the line scan camera 17 (dashed-line rectangle) in FIG. 8. In FIG. 8, the modules 18 of the line scan camera are depicted as diode modules, which are connected with one another using the wiring harness 26. In FIG. 8, the orientation of the line scan camera 17 to the anilox roller 7 is visible. Two sections of the camera 27 and 28, which are each recorded by a camera module 18, are highlighted by dashed-line circles. The section 27 lies at a face edge of the anilox roller 7 and is also provided in the operation of the printing machine with an unimpaired film of ink 22. The section 28 is part of the contact region 10. The consequences of these circumstances are depicted in FIGS. 6 and 7, which depict enlargements of the section 28 (FIG. 6) and 27 (FIG. 7). The cells 30 of the anilox roller 7 are filled with ink 29 in the section 27. The ink reaches to the separators between the cells, because the surface of the anilox roller 7 is indeed merely bladed by the doctor blade 21 of the anilox roller 7. As a result, there results in section 27 a good degree of reflection of the anilox roller, which degree of reflection is largely determined by the relatively smooth film of ink on the surface of the anilox roller. This is not the case in section 28. The cells 30 in this case are largely emptied, the separators are barely wetted by ink 29. The incident radiation, which as a rule comes from an additional radiation source (not shown) is offered a rough surface, which is irregular, and primarily reflects more weakly and diffusely. The difference of the degree of reflection between sections 27 and 28 is therefore significant, a good signal-to-noise ratio results when measurements are taken with appropriate sensors.

Already in the previous figures, the depiction of an external rack is foregone, as it must have the same mechanical functional components as the inking devices and/or printing machines diagrammed. The depiction of control devices, cables, and interfaces is also foregone. In spite of that, reference is explicitly made to the fact that the methods portrayed can be carried out by computer implementation. Often, the control device of the printing machine and/or the control device of an external rack are equipped with corresponding software and hardware components. In the presence of an external rack, the operation can also be divided between the appropriate control devices of the rack and the printing machine.

In FIGS. 10 to 14, different measurement methods, which were already acknowledged in the introductory description, are explained once again in examples. It is also advantageous, with regard to these examples, to establish some type of control devices for automatically implementing these methods. The underlying question for these methods is: At what change in the area coverage of the at least one ink-transporting roller is an optimized operating distance considered to be achieved for the at least two rollers involved in the printing process? In this case, due to requirements of brevity, it is initially only checked which possibilities result for an increasing adjustment of the rollers and the change of the surface structure of the film of ink and/or a removal of the film of ink, which are connected therewith.

It is clear from FIGS. 10 to 14, how the intensity of the [sic] from a camera 17, 24 changes as a function of the operating distance. With regard to optimizing the operating distance between the rollers, these are as a rule converged closer to one another—in the case of largely parallel roller axes. In this case, the distance of the rollers changes in the radial direction r thereof. In the following figures, an increase of the value x stands for this convergence in the radial direction, since the support for one roller is moved in the direction of the other roller. Naturally, the relative position of the two rollers can also be changed in a different way.

The embodiment shown in FIG. 10 is based on a measurement of the light remitted by the ink-transporting roller and/or on the measurement of the intensity I of this light. At the beginning of the test run symbolized by the bracket 32, during which test run the light intensity values are measured, which values result as a function of the convergence of the rollers (the roller distance sinks from left to right, as one roller is adjusted in the x direction toward the other), the light intensity has not yet changed. No contact has yet taken place. Upon achieving a very early kiss print point 31, an ink transfer begins, which can be measured beginning at the point 37 by the sensor system, since the decrease in the light intensity I is already greater here than the measuring tolerance 35 of the sensor system. At this point, the test run 32 ends, which means that for this example, the relative position achieved at point 37 is considered as a first optimized relative position of the two rollers. According to the entire system parameters (sensitivity of the sensor system, type of printing method, ink, etc.) an optimized operating distance 38 can already be achieved here. As a rule, however, more must be done in order to achieve an acceptably optimized operating distance 38. In this case, this takes place in that an additional convergence of the rollers by an offset value 34—thus an amount of distance x—is carried out. The size of the amount of distance can be based on calculations or empirical evidence.

Achieving the optimized operating distance 38 can be verified by measurements, which, however, may often not be necessary.

In FIG. 11, as well, and in the remaining figures, the convergence of the two rollers as a result of the adjustment of one roller in the x direction toward the other is displayed against the remitted light intensity I. In FIG. 11, the light intensity also initially remains at the maximum 42, as no ink transfer takes place. The ink transfer again begins at point 31. The test run 32 does not, however, end at the moment, in which the decrease in the light intensity exceeds a lower detection limit 35, but rather at the moment, in which the decrease in the light intensity exceeds a predetermined threshold value 33. From point 31 up to reaching this threshold value, the rollers have indeed further converged by the adjustment amount 39, however—in the present embodiment—the adjustment is increased (“further positioned”) once again by an offset value 34, until it is assumed that an optimized operation position 38 of the two rollers is achieved.

In FIG. 12, the terms offset 34, threshold value 33, and adjustment amount 39 to threshold value 33 can be explained once again: An offset 34 is a convergence of the rollers by an amount of distance. This can be controlled by the machine control and if necessary is measured by position sensors such as rotary position transducers in spindle motors. If a threshold value 33 (for light intensity I) is predetermined, then the distance between the rollers (by changing x) can be changed up to the point when the threshold value is reached. This results in an adjustment amount 39 to the threshold value 33.

In FIGS. 13 and 14, the progression of the light intensity is depicted as a function of the convergence over a broader range:

As already shown in FIGS. 10 and 11, the light intensity initially is found at a maximum 42. After leaving this maximum (this begins at point 31, as already shown) the graph 45 often assumes a very characteristic progression 46 until it reaches the minimum 43. Within this range, characteristic points 44 can be determined (such as turning points or local maximums), from which statements about the position of an optimized operating position of the two rollers can be made. Thus, in FIG. 13 a situation is depicted, in which the test run is carried out until reaching an optimized printing position. Upon reaching point 38, the control device can calculate or estimate the additional curve range. The control device does not consider further adjustment necessary and ends the test run as well as the adjustment process. It is often even possible during this method (optimizing the relative roller position based on the evaluation of the characteristic progression of function 45) to end the test run prematurely and to achieve the optimized roller position by means of an offset 34.

An embodiment is shown in FIG. 14, in which the test run 32 continues until the minimum 41 is reached. At this point, the rollers are further separated by a calculated value 47 in order to set the optimized operating distance 38.

In relation to FIGS. 10 to 14, light intensity I is exclusively discussed as a measured value. As mentioned at the beginning, however, other measured variables can also assume this role. In conjunction with the invention, it is advantageous when the area coverage per area unit can be measured at the running—that is rotating—roller.

The progressions of graphs 45 shown in the figures can appear in sections of the area or in the entire area. Therefore, it is possible to observe the change in the layer of ink in sections of the contact surface 10 or in the entire contact surface 10 using the methods depicted.

FIG. 15 shows an anilox roller 7, the surface of which is radiated by a radiation source 48 with incident radiation 49. The radiation is remitted by the surface of the anilox roller 7. The remitted radiation 50 is more diffuse than the incident radiation 49. The anilox roller 7, the radiation source 48, and the camera 24 are positioned to each other in such a way that a large portion of the remitted radiation falls into the camera 24. As a rule, this circumstance is ensured by setting the relation of the angle of incidence (to the relevant roller surface) equal to the angle of reflection.

While the image area of FIG. 15 is generated by the axial (z) and radial coordinates (r) of the roller 7, the image area of FIG. 16 is generated by the circumference (φ) and radial coordinates (r). The anilox roller 7 in FIG. 16 is thus rotated with respect to the anilox roller in FIG. 15 by 90°. The radiation source 48 and the camera 24 are positioned differently with respect to the anilox roller. FIGS. 17 and 18 show an enlargement of a section of the surface of an anilox roller 7. In FIG. 17, cells 30 of the anilox roller surface are filled to the edge with ink 29. In FIG. 18, the cells are largely emptied of ink 29. The progression of remitted radiation 50 illustrates the consequences of the circumstances in FIGS. 17 and 18: In FIG. 17, the remission is less diffuse than in FIG. 18, such that in FIG. 17 more light falls into the collecting lens 51 mounted upstream of camera 24 and thus into the camera 24. It should still be mentioned that the light sources 48 are also associated with lenses 51 in FIGS. 17 and 18.

FIGS. 19 and 20 likewise show enlarged sections of the anilox roller surface, wherein FIG. 19 shows cells 30 filled with ink 29, whereas the cells in FIG. 20 are largely emptied. The broader progression of radiation intensity bars in FIG. 20 illustrate the consequences:

The light 50 remitted by the anilox roller 7 is more strongly scattered in FIG. 20 than in FIG. 19, such that in FIG. 20, less light intensity—or fewer photons—arrive in the collecting lens 51. Due to this decrease in intensity, it is clear that an adjustment of the anilox roller 7 toward another roller—such as a plate cylinder—has taken place.

Exactly in view of FIGS. 16 to 20, which depict the surface of anilox rollers in a schematic view, it can be shown that it does not necessarily require an ink transfer and thus a reduction of ink on the roller surface to change the remission behavior of the surface of an ink-transporting roller 7. Rather, in particular with regard to ink-transporting rollers having an uneven surface—such as anilox rollers, cliché rollers, or plate cylinders, but also printing cylinders—it should be assumed that the change of the surface structure already leads to a measurable change of the surface of the film of ink on the roller as a result of a first contact between rollers.

A change of the surface of this type can, for example, consist in a “de-smoothing” of the same—thus in an increase in the “roughness” thereof—thus actual unevenness. Already with regard to a result of this type, a greater scattering of the remitted radiation occurs, such that a first contact between rollers 1, 7, 8, involved in the printing process can be measured.

In addition, a first contact of this type between the rollers can also lead to the fact that ink is displaced from the surface of the roller into cells 30, intermediate spaces between embossed sections of the print image, or into other lower-lying regions of the roller surface without the occurrence of an ink transfer to another cylinder—in general called color splitting. In the last-described case, the reflection behavior of the roller surface can also significantly change. Thus, the ink disappears from the high-lying regions of the roller surface, such that these are no longer covered by a smooth ink layer. The as a rule irregularly embossed elements of the roller surface (often separators between the cells 30, with regard to anilox rollers, pressure active regions with regard to plate cylinders 8) prevent a uniform direct reflection and thus contribute to the generation of more diffuse or non-directionally reflected light with regard to the reflected radiation 50.

In addition to ink removal and the change of the surface structure, naturally an addition of ink resulting from a contact between rollers involved in the printing process can be measured. This can, for example, be the case when the ink addition on a plate cylinder 8 is measured against the already inked anilox roller. For the qualitative change—for example, the measured increase of intensity I of the remitted light 50 as a consequence of the adjustment—then that stated in regard to FIGS. 10 to 14 applies, whereby the intensity decreases and does not increase as a result of the convergence of the rollers. If the ink-transferring cylinder 8, which is inked in such a way, is further adjusted toward a not yet inked cylinder 1 and/or the printing material 9 (see for example FIG. 4), then again a change in the film of ink and therefore—in the case that the light intensity I of the remitted light 50 is the measured variable—a reduction of the light intensity 50 should be recognized (compare FIGS. 10 to 14). The addition of ink, the removal of ink, and the change in the structure of the ink surface fall under the concept: change in the film of ink.

Using the methods depicted, it is therefore possible, among others, to:
recognize a first contact between cylinders 1, 7, 8,
recognize the performance of the contact
test sections 27, 28 of the contact region 10,
disassemble the entire contact region into sections of this type.

The observation can take place at the rotating roller. In this case, the generation of spoilage can be avoided. The completeness and/or smoothness of the ink transfer can be checked. It is advantageous to implement the methods mentioned, and those subsequent, using devices that are installed—for example by programming a control device—for the implementation of said methods.

The measurement of the change in the film of ink can be taken while the rollers are still being adjusted toward each other.

FIG. 21 resembles FIG. 5 insofar as an anilox roller 7 is depicted, which is scanned by a mobile camera. In FIG. 21, however, it is indicated that the camera 24 scans the roller at a point in time, since this roller is already inked with a film of ink 22 at the points, which can absolutely roll off using the plate cylinder 8—as the second cylinder, to which the anilox roller transfers ink. An adjustment of the anilox roller 7 and the plate cylinder 8 with respect to one another has nevertheless not taken place, such that the camera in the region of the scanning regions 53 thereof, which follow one another in the circumferential direction φ, scans an uninfluenced film of ink 22.

This takes place at a rotating anilox roller 7, such that the camera 24 records a reference curve R (FIG. 23). This reference curve R indicates here the progression of the intensity I of the light remitted by the anilox roller as a function of the rotational angle φ of the roller 7. It is advantageous if the film of ink 22 is complete, that means, that the film of ink 22 corresponds to the printing operation.

In FIG. 22, a first adjustment (which has led to contact) has already taken place between the anilox roller 7 and the plate cylinder 8 and a loss of ink can be recognized in the contact region 10 between the cliché 22 and the anilox roller surface.

This loss of ink in the contact region 10 leads to a significant change of the measured value in comparison to the reference curve R measured prior to the adjustment, which curve is depicted in FIG. 23 by the dotted test run curve TM.

It is advantageous to end further adjustment of the cylinders 7, 8 (optimized setting of the relative roller position achieved), when the difference between the test run values TM and the reference values R at an angle position φ of the roller (can be recorded using a rotary position transducer) exceed a certain value (e.g., tolerance values T1 or T2). In a case of this type, the curve TM extends beyond the dashed curves G1 or G2. Also, the progression of the difference between reference values R and test run values TM can underlie the setting of the relative roller positions. Example: The difference TM-R—respectively in a certain angle position φ₁ is derived according to φ.

If the derivation exceeds a certain derivation threshold value K, then the optimized roller position is reached:

d[TM(φ₁)−R(φ₁)]/dφ>K

In FIG. 23, the y axis is indicated with −I. Using this measure takes into account the circumstance that, as a result of the removal of ink and/or the degradation of the film of ink in the contact region 10, in general a significant decrease in the intensity of the remitted light, at least in a certain spectral range, occurs.

It is often advantageous, if the sensors 17, 19, 24 depicted in the figures are pivoted away out of the region of the inking device after scanning the roller. In this case, the sensitive sensors are no longer fouled during the further printing operation. In the pivoted away position, cleaning can take place, which can be implemented for example by a cleaning device provided for this purpose. In this position, a recalibration of the sensors can also be implemented. During changing of ink in the inking device, the spectral sensitivity range of the sensors can be adjusted by filters and/or by loading the semiconductor diodes with a counter voltage.

List of Reference Numbers

| | |
|---|---|
| 1 | Central impression cylinder |
| 2 | Printing unit/inking device |
| 3 | Printing unit/inking device |
| 4 | Printing unit/inking device |
| 5 | Printing unit/inking device |
| 6 | Doctor blade chamber |
| 7 | Anilox roller |
| 8 | Plate cylinder |
| 9 | Printing material |
| 10 | Contact region |
| 11 | Cliché |
| 12 | Arrow in the rotational direction of the impression cylinder |
| 13 | Arrow in the rotational direction of the plate cylinder |
| 14 | Arrow in the rotational direction of the anilox roller |
| 15 | Printing machine |
| 16 | Print image |
| 17 | Line scan camera upstream of the doctor blade chamber |
| 18 | Module of the line scan camera/laser diodes |
| 19 | Line scan camera downstream of the doctor blade chamber |
| 20 | Ink reservoir for the doctor blade chamber 6 |
| 21 | Doctor blade |
| 22 | Unaffected film of ink |
| 23 | Arrow symbolizing the transport direction of the ink |
| | in the inking device |
| 24 | Mobile camera |
| 25 | Arrow indicating movement directions of the camera |
| 26 | Wiring harness for line scan camera 17 |
| 27 | First section of the anilox roller surface |
| 28 | Second section of the anilox roller surface |
| 29 | Ink |
| 30 | Cell |
| 31 | Early kiss print point |
| 32 | Bracket “test run” |
| 33 | Bracket “threshold value” |
| 34 | Arrow “offset” |
| 35 | Threshold value detection/measurement tolerance |
| 36 | Adjustment error upon reaching the threshold value |
| | detection/measurement tolerance |
| 37 | Line (x value) |
| 38 | Optimized operating distance |
| 39 | Adjustment amount to threshold value 33 |
| 40 | Line (x value) |
| 41 | Line (x value, “curve progression determined”) |
| 42 | Maximum I |
| 43 | Minimum I |
| 44 | Characteristic point |
| 45 | Graph/function I as a function of x |
| 46 | Progression of function 45 between minimum 42 and |
| | maximum 43 |
| 47 | Calculated value (x) |
| 48 | Radiation source/lighting unit |
| 49 | Incident radiation |
| 50 | Remitted radiation |
| 51 | Lens |
| 52 | Radiation intensity bar |
| 53 | Scanning region |
| φ | Rotational angle, control variable in the rotational direction φ |
| φ₁ | Angle setting determined for anilox roller 7 |
| z | Axial direction of rollers/cylinders 7, 1, 8 |
| x | Adjustment direction of one roller toward the other |
| | (reducing of the distance therebetween) |
| I | Light or radiation intensity |
| TM | Test run values/measured values |
| T1/T2 | Tolerance values |
| G/G1/G2 | Threshold value |
| K | Derived threshold value |

1. Method for setting an optimized operating distance between at least two cylinders (1, 7, 8) of a printing unit (5), said (5) comprising at least two cylinders (1, 7, 8),
wherein said cylinders (1, 7, 8) transport ink in an ink-transporting direction (23) during the printing process,
wherein the method sets the distance between the at least two cylinders, of which a first cylinder (7) transfers ink during the printing process and a second cylinder (8) receives ink from the first cylinder (7) during the printing process,
wherein the optimized operating distance between the at least two cylinders (1, 7, 8) is set based on the measured values from a sensor device (17, 24),
wherein the sensor device (17, 24) records the change in the film of ink which occurs on at least one cylinder (7, 8) which is involved in transporting ink (29) to the printing material (9),
and wherein the change in the film of ink (22) on the cylinder (7), which the sensor device (14, 24) records, consists in the removal of ink or in the change of the surface of the film of ink as a result of contact pressure, characterized
in that the at least one cylinder (7, 8), at which the change in the film of ink is recorded, is a cylinder which is mounted upstream, when viewed in the ink-transporting direction (23) of the second cylinder (8), which receives ink during the printing process,
and in that the change in the film of ink (22) on the at least one cylinder (7, 8) is carried out while the cylinders are rotating.

2. Method according to claim 1,
characterized in that
the change in the film of ink is recorded at the first cylinder (7), which transfers the ink to a second cylinder, which receives the ink.

3. Method according to claim 1,
characterized in that
the change in the film of ink is recorded at a cylinder (7) which is mounted upstream of the first cylinder (7) which transfers ink in the ink-transport direction (23) to the second cylinder (8), which receives the ink.

4. Method according to claim 1,
characterized in that
the distance between more than two cylinders (1, 7, 8) of a printing unit (5) is set based on the recording of the film of ink (22) on a cylinder (7).

5. Method according to claim 1,
characterized in that
respectively two cylinders (1, 7, 8) are gradually adjusted with respect to one another and that during this adjustment, the change in the film of ink (22) on the one cylinder (7) is recorded and underlies the setting of the distance.

6. Method according to claim 1,
characterized in that
the portion of the surface of the at least one cylinder (7), which can transfer ink, is initially completely inked before the adjustment of the at least two cylinders (7, 8) with respect to one another is carried out.

7. Method according to claim 1,
characterized in that
the sensor device records the change in the film of ink (22) which occurs on a plate cylinder (8) and/or a smooth or anilox roller (7).

8. Method according to claim 1,
characterized
in that the distance of at least three cylinders (1, 7, 8) involved in the printing process is set,
wherein of the at least three cylinders (1, 7, 8), at least two cylinders (7, 8) are involved in the transport of ink (29) to the printing material (9),
in that the sensor device measures the change in the film of ink, which occurs on at least one of the at least two cylinders (7, 8) involved in the transport of ink, which is further distant from the printing material (9).

9. Method according to claim 1,
characterized in that
during the measurements, all cylinders (1, 7, 8) involved in the printing process of a printing unit (5) are adjusted with respect to one another.

10. Method according to claim 1,
characterized in that
the sensor device (17, 24) records the change in the film of ink within the context of a first test run (32) while the distance between the cylinders (1, 7, 8) involved in the printing process is changed,
and a control device ends the first test run (32) when, based on the measured values (I), an initial change in the film of ink is assumed, or when the change in the film of ink exceeds a primary threshold value (33).

11. Method according to claim 1,
characterized in that
the sensor device (17, 24) records the change in the film of ink within the context of a first test run (32) while the distance between the cylinders (1, 7, 8) involved in the printing process is changed,
and a control device ends the test run (32) when a designated characteristic progression of the measured values occurs.

12. Method according to claim 1,
characterized in that
at the end of the first test run (32), the adjusted relative position of the cylinders (1, 7, 8) is changed to the setting of the optimized operating distance,
in that the relative position is changed by a certain amount of distance (34)
and/or
in that the relative position is changed up until a change in the film of ink by a certain amount (33) occurs, which is tracked by means of renewed measurements.

13. Method according to claim 1,
characterized in that
the sensor device (17, 24) records the change in the film of ink (22), which occurs in the contact region (10) of the surface of the at least one cylinder (7, 8), which contacts the subsequent cylinder (1, 7, 8) or the printing material (9) in the printing process.

14. Method according to claim 1,
characterized in that
the sensor device (17, 24) disassembles the area (10), in which said device records the change in the film of ink into sections (27, 28), and/or records sections (27, 28) of said area (10).

15. Method according to claim 1,
characterized in that
the sensor device (17, 24) checks the area (10), in which said device records the change in the film of ink (22), in that said device records the intensity (I) of the light remitted by said area (10).

16. Method according to claim 1,
characterized in that
the change in the film of ink, which the sensor device records, consists in an accumulation of ink and/or a decrease in ink and/or in a change in the surface of the film of ink.

17. Method according to claim 1,
characterized in that
the operating distance between a first group of cylinders (1, 7, 8) involved in the printing process is set, wherein the first group has a first number (N) of cylinders, and the first number is at least three,
wherein the operating distance between a second group of cylinders (1, 7, 8) involved in the printing process is set based on measured values, which relate to the change in the film of ink on at least one of the two cylinders, wherein the second group is a subset of the first group, the second group has a second number (M) of cylinders, and the second number (M) is at least two,
and wherein the operating distance between a third group of cylinders (1, 7, 8) involved in the printing process is set based on measured values, which are obtained in a different way from the measured values used for adjusting the operating distance between the cylinders of the second group from cylinders involved in the printing process, wherein the third group is a subset of the first group, the third group has a third number (O) of cylinders, and the third number (O) is at least two.

18. Method according to claim 1,
characterized in that
the sensor device (17, 24) initially scans at least components of the area (10) of the cylinder, on which the change in the film of ink is recorded, before the at least two cylinders are adjusted with respect to one another.

19. Method according to claim 1,
characterized in that
the sensor device (17, 24) initially scans at least components of the area (10) of the cylinder (7), on which the change in the film of ink is recorded, before the at least two cylinders (1, 7, 8) are adjusted with respect to one another and after at least components of the area (10) of the cylinder, on which the change in the film of ink (22) is recorded, are inked.

20. Method according to claim 1,
characterized
in that the sensor device (17, 24) initially records reference values (R), in that said sensor scans at least components of the area (10) of the cylinder (7), on which the change in the film of ink (22) is recorded as a function of the angle setting (φ) of said cylinder (7) before the at least two cylinders (1, 7, 8) are adjusted with respect to one another,
in that said reference values (R) are compared with test run values (TM), which are obtained at the same angle setting (φ) after or during the adjustment of the at least two cylinders (1, 7, 8),
and in that based on this comparison, the optimized operating distance between the at least two cylinders (1, 7, 8) is set.

21. Method according to claim 1,
characterized in that
the setting of the optimized operating distance of the at least two cylinders (1, 7, 8) takes into account the difference between the reference values (R) and the test run values (TM), which are respectively recorded at an angle position (φ) of the cylinder (8), the surface whereof is scanned.

22. Method according to claim 1,
characterized in that the setting of the optimized operating distance of the at least two cylinders (7, 8) takes into account the progression of the difference between the reference values (R) and the test run values (TM) as a function of the relative position of the at least two cylinders (1, 7, 8),
wherein the difference values at respectively an angle position (φ) of the cylinder (8), the surface whereof is scanned, underlie the setting.

23. Device (5) for determining an optimized operating distance between at least two cylinders (1, 7, 8) involved in the printing process of a printing unit (5),
which (5) contains recesses in which the cylinders (1, 7, 8) are rotatably mounted and adjustable with respect to one another
which (5) contains a control device which is set in such a way that by means of said control unit the optimized operating distance between the at least two cylinders (1, 7, 8) can be determined based on the measured values (I) of a sensor device (17, 24).
and which (5) contains an inking device (6) which inks the first cylinder (7) in the ink-transport direction (23) between the cylinders (7, 8) adjusted with respect to one another,
characterized in that
the sensor device (17, 24) is mounted in an operating position at the first cylinder (7),
the sensor device (17, 24) can record measured values (I) which characterize the change in the film of ink, which film of ink occurs on the first cylinder (7), and
the measured values can be recorded by the sensor device while the cylinders rotate.

24. Device according to claim 1,
characterized by
an optical sensor device (17, 24).

25. Device according to claim 1,
characterized by
an illumination device which stands in an operating position at the first cylinder (7) and at the sensor device (17, 19, 24).

26. (canceled)

27. (canceled)
